(19) United States
(12) Patent Application Publication
(10) Pub. No.: US 2011/0009350 A1
(43) Pub. Date: Jan. 13, 2011

(54) Oil-in-Water Formulation of Avermectins

(76) Inventors: Morten Pedersen, Lemvig (DK); Henriette Woldum, Vojie (DK)

Correspondence Address: JACOBSON HOLMAN PLLC, 400 SEVENTH STREET N.W., SUITE 600, WASHINGTON, DC, 20004, US

(21) Appl. No.: 12/085,165

(22) PCT Filed: Nov. 17, 2006
(86) PCT No.: PCT/DK2006/050068

§ 371 Date: Sep. 23, 2010

Related U.S. Application Data
(60) Provisional application No. 60/738,072, filed on Nov. 21, 2005.

(30) Foreign Application Priority Data
Nov. 18, 2005 (DK) PA 2005 01619

(51) Int. Cl. A01N 43/04; A01P 15/00

(52) U.S. Cl. 514/30; 514/23

(57) ABSTRACT

Oil-in-water emulsion formulations (EW) of avermectins based on esters of fatty acids as solvent and the use of such formulations for the control of crop pests.

### FIELD OF INVENTION

The present invention relates to oil-in-water emulsion formulations (EW) of avermectins based on esters of fatty acids as solvent and to the use of such formulations for the control of pests and protection of crops against such pests.

### BACKGROUND

Abamectin is a compound belonging to the well known class of avermectins which are a group of macrocyclic compounds derived from fermentation products from a strain of Streptomyces avermitilis possessing potent anthelmintic and insecticidal activities. The individual avermectins, either naturally derived or prepared by synthetic means, are usually mixtures of up to 8 major components designated as A₁ₐ, A_{1b} A₂ₐ, A_{2b}, B₁ₐ, B_{1b} B₂ₐ, B_{2b} in various ratios. For instance Abamectin is a mixture of the two closely structurally related components designated B₁ₐ and B_{1b} usually in a 80:20 ratio, whereas the active compound known as Aversectin C further comprises additional components apart from those in Abamectin.

Abamectin is commercially available in the form of emulsifiable concentrates (EC), i.e. formulations wherein the active ingredient is emulsified in an organic solvent. From an environmental point of view such formulations are however not desirable due to the large amount of organic solvent used. In addition, the EC product comprising Abamectin sold under the trademark Vertimec, makes use of N-methyl-2-pyrrolidone which is suspected of being teratogenic. It would thus be desirable to provide the active ingredient in a more environmental and user friendly form, e.g. substitution of the organic solvent totally or in part with water. Such preparations are also attractive from an economical point of view.

Oil-in-water formulations significantly reduces the amount of solvent used, but as disclosed by Mosin et al (Russian Journal of Ecology, Vol. 29, No. 2 1998, pp 127-129) Aversectin C for example tends to degrade significantly over time in the presence of water and even a faster degradation is observed if exposed to light as disclosed by Wislocki et al in Ivermectin and Abamectin, Cambell, W. C.; Ed., New York: Springer-Verlag, 1989, especially pp. 184-185.

In European patent publication no. EP 1210877-A1 and PCT publication no. WO 02/43488-A1 it is suggested to formulate various insecticides, in particular pyrethroids, as oil-in-water emulsions using one or more solvents from the group of esters of aliphatic monocarboxylic acids, esters of aliphatic dicarboxylic acids, esters of aromatic monocarboxylic acids, esters of aromatic dicarboxylic acids and tri-n-allcylphosphates, and optionally a polar co-solvent. Such preparations are said to be stable, but no teaching as to the stability of the active ingredient(s) itself is found in the specifications.

PCT publication no. WO 2004/093886-A1 discloses topical ready-to-use pharmaceutical compositions comprising Ivermectin for human treatment of the skin disease rosacea. The compositions comprise an oily phase comprising one or more fatty substances, surfactant, solvent, gelling agents and water. The fatty substances are e.g. selected among synthetic oils, preferably in combination with a silicone oil. The compositions comprise a low proportion of water immissible co-solvent to Ivermectin and are not suitable for agrochemical use, i.e. in diluted form for crop protection, as they are of a high viscosity and the amount of water immiscible constituents, i.e. fatty substances, are insufficient to keep the active ingredient dissolved especially after dilution with e.g. water.

PCT publication no. WO 95/31898-A1 discloses formulations of various insecticides, in particular pyrethroids, as oil-in-water emulsions using one or more solvents from the group of esters of phthalates or fatty esters derived from vegetable oils, and optionally a polar co-solvent. However, it is not suggested that the compositions have a beneficial effect on the stability of the active ingredient(s) itself.

In European patent application no. EP 933025-A1 emulsifiable concentrates of fungicides or herbicides are disclosed comprising esters of plant oils and water-miscible polar aprotic co-solvents.

In U.S. Pat. No. 5,227,402 aqueous microemulsion formulations of Abamectin are disclosed (e.g. example 11). Although the formulations are said to be stable, no teaching as to the stability of the active ingredient itself is found in the specifications.

Further, microemulsions require use of large amounts of surfactants to ensure stability of the nanodroplets in the aqueous phase and such large amounts of surfactant tends to increase the risk of skin penetration and as such comprise a hazard during handling. Whereas microemulsions appear throughout as transparent or semitransparent preparations with oil droplets usually of a magnitude of 10-200 nm, oil-in-water emulsions are non-transparent and the oil droplets of a magnitude of 1-20 μm. However using high pressure homogenization techniques or similar means in the preparation process can provide oil-in-water formulations having an oil droplet size below 1 μm.

In European patent specification no. EP 45655-A2, stable micro emulsions of Ivermectin suitable for parental or oral administration are provided using co-solvents selected among glycerol formal, propylene glycol, glycerine or polyethylene glycol. The micro emulsions can be further stabilised with inclusion of one or more substrates selected among benzyl alcohol, lidocaine, a paraben or choline.

It has now surprisingly been found that EW-formulations of avermectins with significant stabilisation of the avermectin compound itself can be prepared based on esters of fatty acids as organic solvent.

### DESCRIPTION OF THE INVENTION

The present invention relates in one aspect to a concentrated oil-in-water emulsion formulation for crop protection against pests, comprising
a) one or more pesticidal active ingredients selected among avermectins,
b) one or more solvents selected among esters of fatty acids,
c) an emulsifier system comprising one or more surfactants,
d) water, and
e) one or more co-solvents having a solubility in water of less than 10% at 25° C.,
   wherein the pH-value of the emulsion is higher than 3 and the amount by weight of co-solvent is equal to or higher than the amount by weight of avermectin.

The formulations according to the invention provide a significant stabilization of the active ingredients compared to oil-in-water formulations comprising avermectins according to the prior art and maintain the benefits of oil-in-water emulsions. Further, the formulations significantly reduce the degradation of the avermectin(s) also when exposed to light.

The present invention further provides a method for stabilising avermectins in oil-in-water emulsion formulations using the above composition. Preferably the formulations provide stabilisation of the avermectin(s) to an extent that less than about 5%, more preferably 3%, of the initial concentration of the avermectin(s) has degraded when the formulations are stored at 54° C. for 14 days; or less than about 10%, more preferably 5%, of the initial concentration of the avermectin(s) has degraded when the formulations are stored at 70° C. for 14 days.

The term oil-in-water emulsion formulation means the undiluted formulation. For the purpose of this invention, all percentages expressed herein are percentage by weight, unless otherwise specified.

The avermectin(s) is e.g. selected among Abamectin, Aversectin C, Doramectin, Emamectin, Eprinomectin, Ivermectin, Selamectin and salts thereof and especially selected among Abamectin, Aversectin C and Emamectin, mixtures thereof and salts thereof, e.g. Emamectin benzoate, with Abamectin being the most preferred choice.

The concentration of the avermectins(s) is generally between 0.001 and 30%, preferably 0.1 and 10%, and more preferably 1 and 5% by weight of the total composition (% w/w).

The esters of fatty acids are preferably esters of plant oils. The esters of plant oils (b) are preferably alkyl esters of fatty acids of plant oils, for example obtainable from medium chained fatty acids by esterification with alkanols, and include (C₁-C₂₀)-alkyl (C₅-C₂₂)-fatty acid esters. Preferred fatty acids of these plant oils have a carbon chain length of 5 to 20, in particular 6 to 18 carbon atoms. In a preferred embodiment the alkyl part of the fatty acid esters consist of 1-18 carbon atoms (straight or branched). Preferably (C₁-C₆)-alkyl esters are used (e.g. methyl, ethyl, propyl, iso-propyl, butyl, iso-butyl, sec-butyl, pentyl and hexyl), more preferably the alkyl part consist of 1-3 carbon atoms, even more preferably 1-2 carbon atoms, and most preferably methyl esters of plant oils are used, and even more preferably methylated plant oils wherein the fatty acid has a carbon chain length between 7-16, more preferably 8-14. Examples of esters of fatty acids are Stepan C-25 methyl ester, Stepan C-40 methyl ester, Stepan 653 or Stepan IPM all available from Stepan, or Witconol 2301, Witconol 2307, Witconol 2308, Witconol 2309 all available from Witco Corporation, or ethyl caproate available from SigmaAldrich, or Edenor ME C6-C10, Edenor ME C12 98/100 both available from Cognis or Tegosoft MM and Tegosoft SH both available from Goldschmidt, as well as the Agnique ME series of products available from Cognis such as Agnique ME 890-G and Agnique ME 12C-F. It is advantageous to choose esters of fatty acids with low viscosity to ease formation of the oil-in-water formulation. Further, as the solubility of the avermectins varies among the esters of fatty acids, one may advantageously choose among those having as high a solubility of the avermectin as possible without the need to apply e.g. heating to increase solubility of the avermectin or vigorous stirring during the preparation of the oil phase for the oil-in-water formulation. However as illustrated herein, esters of fatty acids either having a solid or waxy consistency at room temperature are also useful.

The amount of esters of fatty acids is generally between 5 to 50%, preferably 10-40% and more preferably 15-30% by weight of the total composition (% w/w).

Fatty acids are usually obtained from a natural source and are therefore mixtures of acids with various chain lengths. As used herein, the carbon number of a particular fatty acid refers to the number of carbon atoms of the main acid component, i.e. the component prevailing in the highest amount. Thus, apart from an ester of a fatty acid having a specified carbon number, minor amounts of esters of fatty acids having a smaller or higher amount of carbon atoms in the acid part may occur. As an example methyl coconate usually comprises about 45-55% of the main C12 methyl ester, the rest being methyl esters of acids having 6, 8, 10, 14, 16 or 18 carbon atoms in various but individually less amounts than the acid having 12 carbon atoms.

The emulsifier system c) comprising one or more surfactants is chosen among anionic, cationic, nonionic, zwitterionic and polymer surfactants or mixtures thereof.

Examples of suitable anionic surfactants include alkali, alkaline earth or ammonium salts of the fatty acids, such as potassium stearate, alkyl sulfates, alkyl ether sulfates, alkylsulfonates or iso-alkylsulfonates, alkylbenzenesulfonates such as sodium dodecylbenzenelsulfonate, alkylnaphthalenesulfonates, alkyl methyl ester sulfonates, acyl glutamates, alkylsulfosuccinates, sarcosinates such as sodium lauroyl sarcosinate, taurates or ethoxylated and phosphorylated styryl-substituted phenols. Examples of suitable cationic surfactants include halides or alkyltrimethylammonium alkyl sulfates, alkylpyridinium halides or dialkyldimethylammonium halides or dialkyldimethylammonium alkyl sulfates. Examples of suitable nonionic surfactants include alkoxylated animal or vegetable fats and oils such as corn oil ethoxylates, castor oil ethoxylates, talo fat ethoxylates, glycerol esters such as glycerol monostearate, fatty alcohol alkoxylates and oxoalcohol alkoxylates, fatty acid alkoxylates such as oleic acid ethoxylates, alkylphenol alkoxylates such as isononylphenol ethoxylates, fatty amine alkoxylates, fatty acid amide alkoxylates, sugar surfactants such as sorbitan fatty acid esters (sorbitan monooleate, sorbitan tristearate), polyoxyethylene sorbitan fatty acid esters, alkyl polyglycosides, ethoxylated styryl-substituted phenols, N-alkylgluconamides, alkylmethyl sulfoxides, alkyldimethylphosphine oxides such as tetradecyldimethylphosphine oxide.

Examples of suitable zwitterionic surfactants include alkylbetaines, alkylamidobetaines, amino-propionates, aminoglycinates, imidazolinium betaines and sulfobetaines.

Examples of polymer surfactants include di-, tri- or multi-block polymers of the (AB)x, ABA and BAB type, such as polyethylene oxide block polypropylene oxide, polystyrene block polyethylene oxide, AB comb polymers such as polymethacrylate comb polyethylene oxide or polyacrylate comb polyethylene oxide.

The surfactants mentioned are all known compounds.

The amount of surfactant(s) in the formulations is generally between 0.1-20%, preferably between 0.5-15% and more preferably between 1-10% by weight of the total composition (% w/w).

It is preferred to use as emulsifier system, solely one or more surfactants selected among anionic surfactants, more preferably anionic surfactants selected among ethoxylated and phosphorylated styryl-substituted phenols and alkyl ether sulfates.

To further improve the stability of the avermectin(s) and the formulation as such, one or more co-solvents, i.e. component e) which are different from the components b), are included in the formulations and said co-solvents are totally insoluble or only sparingly soluble in water. By sparingly soluble in water is meant co-solvents that have a solubility in water of less than 10 g pr 100 ml water (i.e. less than 10%) at 25° C., preferably less than 7% and more preferably less than 5% and even more preferably less than 1%. For a list of solvent properties see for example Handbook of organic solvent properties, published by Arnold (1996) or The Properties of Solvents, Yizhak Marcus, published by Wiley (1998), especially table 4.6. By incorporating a water insoluble co-solvent the solubility of the avermectins in the oil phase of the formulation is increased and secures that the avermectins remain solubilised before and after dilution of the concentrated compositions to use concentrations. By remaining solubilised after dilution crystallization of the active ingredient and in turn blocking of filters and/or nozzles in the spray equipment during application is avoided. Further, to ensure a high and fast biological activity, it is important that the avermectins are delivered to the target pest or crop infested or likely to be infested by such pest in solubilised form in order to relative quickly penetrate the skin or plant material, as avermectins will degrade quickly when exposed directly to light on the treated surface. Important target pests of avermectins are usually of the sucking and chewing type, thus the pest needs to ingest, i.e. by chewing or sucking on plant material, for the avermectins to have the highest effect.

Among examples of co-solvents are aromatic hydrocarbons derived from benzene, such as, for example, toluene, xylenes, mesitylene, diisopropylbenzene and its higher homologs, indane and naphthalene derivatives, such as 1-methylnaphthalene, 2-methylnaphthalene; C5-C12 aliphatic hydrocarbons (straight, branched or cyclic), such as, for example, pentane, hexane, cyclohexane, octane, 2-ethylhexane, decane; C5-C10 aliphatic alcohols (straight or branched), in particular C6-C9, such as hexanol, 2-ethyl butanol, heptanol, octanol, 2-octanol, and 2-ethylhexanol; aromatic alcohols such as benzyl alcohol, cyclic aliphatic ketones such as cyclohexanone; mixtures of aromatic and aliphatic hydrocarbons, such as, for example, the corresponding “aromatic” mineral oils, such as mineral oils from the Solvesso series (available from Exxon) and Shell Fluid 2613 and 2613/8M (both available from Shell); halogenated aliphatic hydrocarbons, such as methylene chloride; halogenated aromatic hydrocarbons, such as chlorobenzene, and dichlorobenzenes; and mixtures thereof.

Among preferred co-solvents are straight, branched or cyclic C5-C12 aliphatic hydrocarbons; straight or branched C5-C10 aliphatic alcohols; cyclic aliphatic ketones and mineral oils as well as mixtures thereof. More preferred are straight or branched C5-C10 aliphatic alcohols and cyclohexanone, optionally in combination with one or more mineral oils. Hexanol or octanol being particularly preferred as the C5-C10 aliphatic alcohol and is optionally used in combination with one or more mineral oils.

The amount of co-solvent(s) is generally between 0.1-30%, preferably 1-25%, and more preferably 5-20% (% w/w).

To obtain the desired stability of avermectin in the oil-in-water emulsion, a certain amount of co-solvent having a solubility in water of less than 10% at 25° C. is required. According to the invention the amount of co-solvent is at least equal to the amount of avermectin. Suitably, the amount of co-solvent is higher than the amount of avermectin by weight (w/w). In an aspect of the invention, the weight ratio of avermectin to co-solvent is from 1:1 to 1:100, preferably 1:1 to 1:50, and most preferred 1:1 to 1:20. Without it being desired to be bound by theory, it is presently believed that the co-solvent helps maintain the avermectin solubilized in the oily droplets of the emulsion. In the event, the amount of co-solvent is lower than the amount of avermectin a tendency for the active component to precipitate is observed, especially after dilution of the concentrated emulsion of the invention with water. However, when the amount of co-solvent is at least equal to the amount of avermectin, the active constituent is maintained in solution phase in the oily droplets. An amount of the co-solvent in excess of the weight ratio of avermectin to co-solvent of 1:100 may be used for special emulsions.

It has been found that the pH value of the emulsions, i.e. prior to dilution in for example spraying equipment, have an influence on the stability of the avermectin. If the pH-value of the final emulsion is lower than 3, a significant degradation of the active ingredient is observed. A preferred pH of the emulsions prior to dilution is between 3 and 12, more preferably 4 and 12 and yet more preferably 4 and 11 and even more preferably 5 and 10, with a pH of 6-9 being most preferred. However, one need not necessarily add pH-adjusters as the emulsifier system by itself including any optionally auxiliaries, depending on choice of components, may ensure that the pH-value of the final emulsion is within the preferred range. If appropriate, the amounts of pH-adjusters is at ones option but are suitably present to ensure a pH-value of the emulsion higher than 3. Depending on solubility, the pH-adjusters are included in either the organic or aqueous phase. pH-adjusters include both acids and bases of the organic or inorganic type. Preferred pH-adjusters include organic acids and alkali metal compounds. The organic acids include those such as citric, malic, adipic, cinnamic, fumaric, maleic, succinic, and tartaric acid, and the mono-, di-, or tribasic salts of these acids are suitable organic acid salts. Suitable salts of these acids are the soluble or meltable salts and include those salts in which one or more acidic protons are replaced with a cation such as sodium, potassium, calcium, magnesium, and ammonium. Alkali metal compounds include hydroxides of alkali metals such as sodium hydroxide and potassium hydroxide, carbonates of alkali metals such as sodium carbonate and potassium carbonate, hydrogencarbonates of alkali metals such as sodium hydrogencarbonate and alkali metal phosphates such as sodium phosphate.

Further optionally auxiliaries which may be included in either the organic or aqueous phase (depending on solubility) include thickeners, film-forming agents, antifreeze agents, preservatives, antifoaming and defoamer agents, spreading agents, stickers, wetting agents, structuring agents, stabilisers, UV-protectants and one or more additional insecticides different from the avermectin(s). Such auxiliaries are generally known within the art of agrochemical formulation chemistry, and although a specific ingredient is classified as falling within one category, it may well serve the purpose of any of the others.

Thickeners and film-forming agents include starches, gums, casein and gelatine, polyvinyl pyrrolidones, polyethylene and polypropylene glycols, polyacrylates, polyacrylamides, polyethyleneimines, polyvinyl alcohols, polyvinyl acetates, and methyl-, hydroxyethyl- and hydroxypropylcelluloses and derivatives thereof

Examples of the antifreezing agent include ethylene glycol, diethylene glycol, propylene glycol and the like. Typical preservatives include methyl and propyl parahydroxybenzoate, 2-bromo-2-nitro-propane-1,3-diol, sodium benzoate, formaldehyde, glutaraldehyde, O-phenylphenol, benzisothiazolinones, 5-chloro-2-methyl-4-isothiazolin-3-one, pentachlorophenol, 2-4-dichlorobenzylalcohol and sorbic acid and derivatives thereof.

Preferred anti-foaming and defoamer agents are silicone based compounds e.g. polyalkylsiloxanes.

The optional additional insecticide (including acaricides and nematicides) can advantageously be included for example to widen the spectrum of action or to prevent the build-up of resistance. Suitable examples of such additional insecticides are e.g.: acephate, acetamiprid, acrinathrin, alanycarb, aldicarb, alphamethrin, amitraz, azadirachtin, azinphos, azocyclotin, Bacillus thuringiensis, bendiocarb, benfuracarb, bensultap, betacyfluthrin, bifenazate, bifenthrin, bistrifluron, BPMC, brofenprox, bromophos, bufencarb, buprofezin, butocarboxin, butylpyridaben, cadusafos, carbaryl, carbofuran, carbophenothion, carbosulfan, cartap, chloethocarb, chloroethoxyfos, chlorfenapyr, chlorofenvinphos, chlorofluazuron, chloromephos, chlorpyrifos, chromafenozide, cis-resmethrin, clothianidin, clocythrin, clofentezine, cyanophos, cycloprothrin, cyfluthrin, cyhalothrin, cyhexatin, cypermethrin, cyromazine, deltamethrin, demeton, difenthiuron, diazinon, dichlofenthion, dichlorvos, dicliphos, dicrotophos, diethion, diflubenzuron, dimethoate, dimethylvinphos, dinotefuran, dioxathion, disulfoton, edifenphos, esfenvalerate, ethiofencarb, ethion, ethofenprox, ethoprophos, etoxazole, etrimphos, fenamiphos, fenzaquin, fenbutatin oxide, fenitrothion, fenobucarb, fenothiocarb, fenoxycarb, fenpropathrin, fenpyrad, fenpyroximate, fenthion, fenvalerate, fipronil, flonicamid, fluazinam, fluazuron, flucycloxuron, flucythrinate, flufenoxuron, flufenprox, fluvalinate, fonophos, formothion, fosthiazate, fubfenprox, furathiocarb, gamma-cyhalothrin, HCH, heptenophos, hexaflumuron, hexythiazox, imidacloprid, indoxacarb, iprobenfos, isazophos, isofenphos, isoprocarb, isoxathion, lambda-cyhalothrin, lufenuron, malathion, mecarbam, mevinphos, mesulfenphos, metaldehyde, methacrifos, methamidophos, methidathion, methiocarb, methomyl, methoxyfenozide, metolcarb, milbemectin, monocrotophos, moxidectin, naled, nitenpyram, omethoate, oxamyl, oxydemethon M, oxydeprofos, parathion A, parathion M, permethrin, phenthoate, phorate, phosalone, phosmet, phosphamidon, phoxim, pirimicarb, pirimiphos, profenofos, promecarb, propaphos, propoxur, prothiofos, prothoate, pymetrozin, pyrachlophos, pyridaphenthion, pyresmethrin, pyrethrum, pyridaben, pyrimidifen, pyriproxifen, quinalphos, salithion, sebufos, silafluofen, spinetoram, spinosad, spirodiclofen, sulfotep, sulprofos, tebufenozid, tebufenpyrad, tebupirimiphos, teflubenzuron, tefluthrin, temephos, terbam, terbufos, tetrachlorvinphos, thiacloprid, thiafenox, thiamethoxam thiodicarb, thiofanox, thiomethon, thionazin, thuringiensin, tralomethrin, triarathen, triazophos, triazuron, trichlorfon, triflumuron, trimethacarb, vamidothion, XMC, xylylcarb, zetamethrin.

If present it is preferred to include one or more insecticides chosen among the natural or synthetic pyrethroids e.g. as found above and especially chosen among acrinathrin, cypermethrin, cyfluthrin, cyhalothrin, deltamethrin, fenvalerate and tefluthrin, including any of the previous mentioned compounds in its partially or fully resolved isomeric form. Particularly preferred is acrinathrin or gamma-cyhalothrin.

The substitution of the additional insecticide and/or further addition of other known active compounds, such as herbicides, fungicides, fertilisers or growth regulators, is also possible.

The invention also relates to a process for producing an oil-in-water emulsion formulation as described herein comprising the steps of:
I. preparing an organic phase comprising the one or more esters of fatty acids, the one or more avermectin(s), the one or more co-solvent(s) having a solubility in water of less than 10% at 25° C., and optionally further auxiliaries in the organic phase;
II. preparing an aqueous phase comprising water, the emulsifier system comprising one or more surfactants, and optionally further hydrophilic auxiliaries; and
III. mixing the organic phase and the aqueous phase under agitation to obtain an oil-in-water emulsion.

As the skilled person will easily recognise, the order of addition of the various ingredients used in both the organic and aqueous phase is of minor importance. This also applies to the order of combining the organic phase with the aqueous phase. Some of the optionally auxiliaries may even be added after the mixing of the organic and aqueous phase. One skilled in the art will further recognise that any one of a variety of apparatus may be used to accomplish the mixing steps. Intensive homogenisation is not required but can improve the general homogeneity of the emulsion. Further, if a small oil droplet size is desired intensive homogenisation is a conceivable method. In either of the above steps, heat may be applied to ease the formation of a homogeneous phase.

The invention further relates to the use of oil-in-water emulsion formulations as described herein for the control of pests and protection of crops against such pests, said use comprise applying the emulsion, preferably in diluted form (e.g. aqueous diluted form), to the pests or to plants, plant seeds, soil, surfaces and the like infested with pests or likely to be occupied by pests. For crop protection purposes, the formulations of the present invention can be used to fight pests such as for example aphids, mites, tics, nematodes, acarina, roaches, ants and the like that infest or is likely to infest crops.

The formulations according to the invention are particular suitable for use against pests from the genera Aculus, Alabama, Anticarsia, Hemisia, Choristoneura, Epilachna, Frankliniella, Laspeyresia, Leptinotarsa, Liriomyza, Lymantria, Keiferia, Panonchus, Phtorimaea, Phyllocnistis, Phyllocoptruta, Pieris, Plutella, Polyphagotarsonemus, Pseudoplusia, Psylla, Sciryhothrips, Spodoptera, Tetranychus, Trialeurodes, Trichoplusia, for example in cotton, soya, vegetable, fruit, citrus, wine and maize crops.

The formulations according to the invention show bioefficacy comparable to that of conventional EC formulations but at the same time avoids the use of large amounts of hazardous organic solvents and as such are more environmental and user friendly. The formulations have for a crop protection purpose an excellent crop-safety profile, i.e. they can be applied without causing phytotoxic damage on crops. Low phytotoxicity is of importance and it is of special importance when spraying on susceptible crops such as for instance apples, ornamentals and papaya. The phytotoxic effect is especially pronounced when applied to a plant under stress conditions such as drought, or when formulated goods are applied in combination with crop oils (penetration accelerators) as is commonly done in practice.

Further, the formulations significantly reduce the degradation of the avermectin(s) also when exposed to light.

The formulations according to the invention have the following characteristics: A volume-surface mean diameter in the range 0.05-20 preferably 0.1-10 μm, high flash point and are white and free-flowing (200-55000 cP, preferably 200-25000 cP depending on the particular composition of the formulation) following preparation.

While concentrated formulations are more preferred as commercially available goods, the end consumer uses, as a rule, dilute compositions. Such dilute compositions are part of the present invention.

The invention is illustrated by the following examples:

### Example 1

1.90 g Abamectin (94.00%) is dissolved in 31 g solvent mix consisting of 17.9 g methylated fatty acid (Agnique ME 890G), 7.1 g n-octanol and 6.0 g Shell Fluid 2613/8M. A total amount of 0.82 g of preservative, sticker and thickener is added and dissolved. 60.8 g of aqueous phase consisting of a buffer agent, anionic emulsifiers (6.3% w/w of the emulsion) and water is prepared. The emulsification is performed in one of two ways, both resulting in an oil-in-water emulsion of comparable electric conductivity and volume-surface mean diameter of the emulsion droplets. 1) Under vigorous stirring (3000-4000 rpm), the aqueous phase is added to the organic phase and stirring is continued until the volume-surface mean diameter is in the range 0.1-10 μm. 2) Under vigorous stirring (3000-4000 rpm) the organic phase is added to the aqueous phase and stirring is continued until the volume-surface mean diameter is in the range 0.1-10 μm. Adjustment of pH and viscosity when relevant are done following the emulsification process. The preparation appears as a white non-transparent emulsion.

### Example 2

Oil-in-water emulsions comprising Abamectin as active ingredient and solvent mixtures of a methylated fatty acid (Agnique ME 890G), n-octanol and Shell Fluid 2613/8M are prepared as described in example 1 at a range of pH values and the stability of the active ingredient in accelerated storage tests at 54° C. and 70° C. for 14 days is determined, see table 1. The composition (% w/w) of the studied emulsion is as follows: 1.9% abamectin, 19.0% Agnique ME 890G, 7.6% n-octanol, 6.4% Shell fluid 2613/8M, 1.0% preservative, antifoam agent, sticker, thickener and citric acid, 7.0% anionic emulsifiers (Soprophor FLK/Dispersogen LFS mixture) and water up to 100%. The formulation is divided in six and pH is adjusted using 1M NaOH according to the pH values indicated in table 1. The preparations appear as white non-transparent emulsions.

TABLE 1
Accelerated stability data for Abamectin oil-in-water using a methylated
fatty acid as solvent and octanol and Shell Fluid 2613/8M as co-
solvents at different pH values.

| | Initial | |
|---|---|---|
| | content of | Content of Abamectin after |
| | Abamectin | storage for 14 days at 54° C. |
| pH | (% w/w) | ( ) % Abamectin left |
| 3.01 | 1.56 | 1.48 (94.9) |
| 4.93 | 1.54 | 1.53 (99.4) |
| 6.07 | 1.55 | 1.54 (99.4) |
| 7.50 | 1.54 | 1.52 (98.7) |
| 8.98 | 1.55 | 1.54 (99.4) |
| 10.92 | 1.54 | 1.53 (99.4) |

### Example 3

An oil-in-water emulsion comprising either Ivermectin, Emamectin benzoate or Aversectin C as the active ingredient and various alkylated fatty acids, n-octanol and Shell Fluid 2613/8M as solvents was prepared according to table 2 applying the method in example 1 using premium grade of inerts and an emulsifying agent. The pH of the emulsion is adjusted to approximately 7 using NaOH and the storage stability of the prepared emulsion is studied using accelerated storage tests at 54° C. for 14 days. The preparations appear as white non-transparent emulsions. The results of the storage tests are given in table 2.

TABLE 2
Composition and pH of formulations with Ivermectin, Emamectin
benzoate and Aversectin C and data for accelerated storage.
Values in % w/w.

| | | Emamectin | Aversectin |
|---|---|---|---|
| Ingredient | Ivermectin | benzoate | C |
| AI | 1.90 | 0.97 | 1.95 |
| Stepan IPM (isopropylmyristate) | | | 19.05 |
| Stepan 25 (methyl-caprylate/ | | 19.20 | |
| -decanoate) | | | |
| Stepan 40 (methyl laurate) | 18.87 | | |
| n-octanol | 7.80 | 7.71 | 7.60 |
| Shell Fluid 2613/8M (mineral oil) | 6.34 | 6.44 | 6.42 |
| Propyl parahydroxybenzoat | 0.11 | 0.11 | 0.11 |
| (preservative) | | | |
| Agrimer AL-10LC (PVP | 0.53 | 0.53 | 0.54 |
| derivative) | | | |
| Rhodopol 23 (xanthan gum) | 0.23 | 0.23 | 0.24 |
| Citric acid monohydrate | 0.11 | 0.11 | 0.11 |
| Soprophor FLK(anionic emulsifier) | 1.69 | 1.75 | 1.70 |
| pH adjuster 1M NaOH | 0.85 | 0.59 | 0.53 |
| Distilled water | Add 100 | Add 100 | Add 100 |
| pH | 6.62 | 6.52 | 6.54 |
| % AI after storage 14 days at | 98.9 | 99.2 | 99.0 |
| 54° C. | | | |

The efficacy of the formulation containing Emamectin benzoate was tested in a greenhouse assay. For the greenhouse assay the diluted formulation was sprayed on bean plants in a spray cabinet and the species tested was transferred to the plants (mites and thrips respectively) after the leaf surfaces had dried. The test on Spodoptera exiqua was conducted as a dip-test where Tradescandia crassifolia leaves are dipped in the test solution, dried and then each leaf is infested with 5 Spodoptera exigua.

TABLE 3
Calculated ED 50 values for the greenhouse assay of the Emamectin
benzoate formulation prepared according to table 2 on different
species.

| | Emamectin | | Commercial | |
|---|---|---|---|---|
| | benzoate | | Abamectin | |
| | EW | | EC | |
| | ED 50 | Confidence | ED 50 | Confidence |
| | (g/ha) | interval (95%) | (g/ha) | interval (95%) |
| Tetranycus urticae | 8.89 | 4.85-16.3 | 0.5 | 0.3-0.9 |
| on bean | | | | |
| Frankliniella | 0.08 | 0.02-0.3 | 3.3 | 1.2-8.8 |
| occidentalis on bean | | | | |
| | ED 50 | Confidence | ED 50 | Confidence |
| | (ppm) | interval (95%) | (ppm) | interval (95%) |
| Spodoptera exiqua | 0.0009 | 0.0007-0.0011 | 18.4 | 15-22.5 |
| on tradescantia | | | | |
| crassifolia | | | | |

In a similarly performed dip-test on S. exiqua the prepared Emamectin benzoate EW showed results not significantly different to a commercial Emamectin benzoate EC formulation at concentrations of 0.001 ppm and 0.1 ppm.

### Example 4

An Abamectin 18 g/l oil-in-water emulsion comprising Agnique ME 890 G, n-octanol and Shell Fluid 2613/8M as solvents and further auxillaries was prepared in accordance with the procedure outlined in example 1 using premium grade of inerts. After preparation the volume-surface mean diameter was in the range 1-3 μm.

The emulsion was then treated in a high-pressure (intensive) homogenizer. After the treatment the mean diameter of the droplets was well below 1 μm. The preparation appear as a white non-transparent emulsion.

### Example 5

Abamectin 18 g/l oil-in-water emulsions comprising various solvent phases were prepared in accordance with the procedure outlined in example 1 using premium grade of inerts. Solvents applied in the examples are chosen among Agnique ME 890G (methyl caprylate) and Agnique ME 12C-F (C12 methyl coconate). Co-solvents applied include n-octanol, cyclohexanone and 1-hexanol. In all the formulations pH is adjusted to approximately 7 and for all formulations the stability of the emulsion and the stability of the active ingredient is high (accelerated storage for 14 days at 54° C.). The preparations appear as white non-transparent emulsions.

TABLE 4
Composition of Abamectin oil-in-water emulsions. Values in % w/w.

| Ingredient | Function | A | B | C |
|---|---|---|---|---|
| Abamectin | AI | 1.91 | 1.91 | 1.93 |
| Agnique ME 12C-F | Solvent | | | 19.1 |
| (methylated fatty acid, | | | | |
| primarily C12) | | | | |
| Agnique ME 890G | Solvent | 19.0 | 18.9 | |
| (methylated fatty acid) | | | | |
| n-octanol | Co-solvent | | | 7.63 |
| Cyclohexanone | Co-solvent | 7.61 | | |
| 1-hexanol | Co-solvent | | 7.64 | |
| Shell Fluid 2613/8M | Co-solvent | 6.38 | 6.38 | 6.42 |
| Propyl | Preservative | 0.11 | 0.11 | 0.11 |
| parahydroxybenzoat | | | | |
| Agrimer AL-10LC | Sticker | 0.53 | 0.53 | 0.53 |
| (PVP derivative) | | | | |
| Rhodopol 23 | Thickener | 0.24 | 0.23 | 024 |
| (xanthan gum) | | | | |
| Citric acid | pH-adjuster | 0.11 | 0.11 | 0.11 |
| monohydrate | | | | |
| Soprophor FLK | Emulsifier | 1.70 | 1.73 | 1.71 |
| (anionic) | | | | |
| Dispersogen LFS | Emulsifier | 5.39 | 5.31 | |
| (anionic) | | | | |
| pH adjuster 1M NaOH | pH-adjuster | 0.14 | 0.13 | 1.25 |
| Distilled water | | Add 100 | Add 100 | Add 100 |
| pH | | 6.25 | 6.49 | 6.54 |
| % AI after storage | | 98.8 | 99.4 | 100 |
| 14 days at 54° C. | | | | |

### Example 6

### Comparative

Abamectin 18 g/l oil-in-water emulsions containing various oil phases and/or with variation of pH-value of the emulsions were prepared in accordance with the procedure outlined in example 1 using premium grade of inerts and an optimal combination of emulsifying agents in each emulsion produced. Only the necessary amount of organic solvents was applied in order to keep the Abamectin dissolved in the oil phase. The stirring speed during the emulsion formation was regulated such that the volume-surface mean diameter was in the range 1-20 μm after production.

Results are provided in table 5, and for the oil-in-water emulsions of compositions A through H the stability of the active ingredient is much lower than for oil-in-water emulsions prepared according to the present invention.

TABLE 5
values in % w/w

| Ingredient | Function | A | B | C | D |
|---|---|---|---|---|---|
| Abamectin | Active | 1.66 | 1.46 | 1.94 | 1.621 |
| Technical malathion | Solvent | 30 | | | |
| N-methylpyrrolidone | Solvent | | 3.5 | 4.2 | |
| Octanol | Solvent | | 3.9 | | |
| Norpar 15 (mineral oil) | Co-solvent | | | 0.9 | |
| Agnique ME 890 G (methylated fatty acid) | Solvent | | 10 | | |
| 1-hexanol | Solvent | | | 4.2 | |
| Genagen 4296 (dimethylamide of fatty acid) | Solvent | | | | 30.7 |
| Propylene glycol | Anti freeze | | | | 16 |
| Soprophor FLK (anionic) | Emulsifier | | | | 1.6 |
| Emulsifier Blend I (anionic and nonionic blend) | Emulsifier | 7.4 | | | |
| LFH (anionic) | Emulsifier | | 0.72 | | |
| Phenylsulphonate CA (anionic) | Emulsifier | | 1.1 | | |
| Emulsifier Blend II (anionic and nonionic blend) | Emulsifier | | | 6.7 | |
| BHT (2.6-di-tert-butyl-4-methyl phenol | Stabiliser | | | 0.18 | |
| Hydrogen peroxide | Stabiliser | 0.4 | | | |
| Rhodopol 23 (xanthan gum) | Thickener | | | | 0.22 |
| Carbopol 980 (polyacrylic acid) | Thickener | 0.4 | | | |
| Sipernat S22 (a silica) | Structure | | | | 1.5 |
| Van gel 4% solution (clay) | Structure | | | | 6.25 |
| Propyl parahydroxybenzoate | Preservative | | | | 0.1 |
| Citric acid dehydrate | pH-adjuster | 0.28 | | | 0.1 |
| Agrimer AL 10 (PVP derivative) | Sticker | | | | 0.5 |
| Rhodorsil 426R and Rhodorsil 416 (silicone oil) | Defoamer | | | | 0.25 |
| Water up to | | 100 | 100 | 100 | 100 |
| pH of emulsion | | 5.0 | 2.5 | 6.7 | 4.2 |
| Abamectin content after storage for 14 days at 54° C. | | 1.48 (89%) | 0.03 (2%) | 1.59 (82%) | 1.506 (92.9%) |
| Ingredient | Function | E | F | G | H |
| Abamectin | Active | 1.575 | 1.67 | 1.627 | 1.21 |
| Genagen 4166 (dimethylamide of fatty acid) | Solvent | 30.7 | | | |
| Agsolex 8 (N-octyl pyrrolidone) | Solvent | | 30.7 | | |
| Agsolex 12 (N-dodecyl pyrrolidone) | Solvent | | | 30.7 | |
| Agnique ME 890 G (methylated fatty acid) | Solvent | | | | 7 |
| Diisopropyl biphenyl | Solvent | | | | 3.8 |
| Propylene glycol | Anti freeze | 16 | 16 | 16 | |
| LFH (anionic) | Emulsifier | | | | 1.0 |
| Phenylsulphonate CA (anionic) | Emulsifier | | | | 0.8 |
| Soprophor FLK (anionic) | Emulsifier | 1.6 | 1.6 | 1.6 | |
| Rhodopol 23 (xanthan gum) | Thickener | 0.22 | 0.22 | 0.22 | |
| Sipernat S22 (a silica) | Structure | 1.5 | 1.5 | 1.5 | |
| Van gel 4% solution (clay) | Structure | 6.25 | 6.25 | 6.25 | |
| Propyl parahydroxybenzoate | Preservative | 0.1 | 0.1 | 0.1 | |
| Citric acid dehydrate | pH-adjuster | 0.1 | 0.1 | 0.1 | |
| Agrimer AL 10 (PVP derivative) | Sticker | 0.5 | 0.5 | 0.5 | |
| Rhodorsil 426R and Rhodorsil 416 (silicone oil) | Defoamer | 0.25 | 0.25 | 0.25 | |
| Water up to | | 100 | 100 | 100 | 100 |
| pH of emulsion | | 4.3 | 4.2 | 4.0 | 2.7 |
| Abamectin content after storage for 14 days at 54° C. | | 1.467 (93.1%) | 1.505 (90.1%) | 1.485 (91.3%) | 0.09 (7.4%) |

### Example 7

### Comparative

The stability of Abamectin in water at various pH-values and temperatures was determined. 194.4 mg of Abamectin was dissolved in 10 ml methanol and 1 ml of the solution transferred to 100 ml of de-mineralised water and a part of this was transferred to a buffer solution. The sample was kept in the dark and the solution analysed using a HPLC. Results are provided in table 6.

TABLE 6
Degradation of Abamectin in water at various pH-values and
temperatures. Buffer pH 4: Potassium biphthalate/NaOH;
pH 7: Sodium phosphate/Potassium phosphate; pH 9: Sodium
tetraborate.

| | |
|---|---|
| | Abamectin |
| | concentration |
| Time of | (ppm) |

| Temp (° C.) | measurement (days) | pH 4.0 | pH 7.0 | pH 9.0 |
|---|---|---|---|---|
| 50 | Initial | 3.495 | 3.327 | 3.555 |
| | 7 | 1.054 | 2.952 | 1.265 |
| | 14 | 0.383 | 2.780 | 0.519 |
| | 21 | 0.123 | 2.194 | 0.205 |
| | 28 | 0.0609 | 1.949 | 0.0628 |
| 25 | Initial | 3.495 | 3.327 | 3.555 |
| | 7 | 3.130 | 3.188 | 3.005 |
| | 14 | 2.782 | 3.040 | 2.596 |
| | 21 | 2.566 | 2.829 | 2.380 |
| | 28 | 2.524 | 2.676 | 2.287 |

### Example 8

### Comparative

The stability of Abamectin in water exposed to light at various pH-values was determined. 194.4 mg of Abamectin was dissolved in 10 ml methanol and 1 ml of the solution transferred to 100 ml of demineralised water and a part of this transferred to a buffer solution. The solution was exposed to light (5000-6000 lux) at 25° C. and analysed using a HPLC. Results are provided in table 7.

TABLE 7
Degradation of Abamectin in water at various pH-values with or without
light exposure at 25° C.
Buffer pH 4: Potassium biphthalate/NaOH; pH 7: Sodium
phosphate/Potassium phosphate; pH 9: Sodium tetraborate.

| | | Abamectin | | |
|---|---|---|---|---|
| | Time of | concentration (ppm) | | |
| Condition | measurement (days) | pH 4.0 | pH 7.0 | pH 9.0 |
| Light | Initial | 3.495 | 3.327 | 3.555 |
| | 7 | 2.923 | 2.941 | 3.163 |
| | 14 | 2.332 | 2.529 | 2.810 |
| | 21 | 1.961 | 2.223 | 2.360 |
| | 28 | 1.666 | 2.034 | 2.173 |
| Dark | Initial | 3.495 | 3.327 | 3.555 |
| | 7 | 3.130 | 3.188 | 3.005 |
| | 14 | 2.782 | 3.040 | 2.596 |
| | 21 | 2.566 | 2.829 | 2.380 |
| | 28 | 2.524 | 2.676 | 2.287 |

The results are average of two tests in each case.

### Example 9

An oil-in-water emulsion formulation of Abamectin is prepared according to example 1. The composition of the emulsions is as follows: 1.8% Abamectin, 17.4% Agnique ME 890G, 7.0% Octanol, 5.8% Shell Fluid 2613/8M, 2.8% preservative, antifoam agent, sticker, thickener and buffer, 6.5% total of two anionic emulsifiers (Soprophor FLK and Dispersogen LFS) and water up to 100%.

1 ml of emulsion is diluted to a total volume of 100 ml and 1 ml is transferred to each of 4 crystallisation bowls and left to dry in darkness. Two bowls are exposed to light in a Heraeus Suntest CPS unit for a period of two hours using maximum effect and two bowls are left in darkness also for two hours. After exposure the formulation residue is dissolved in 10 ml ethanol and the remaining amount of Abamectin is determined by HPLC analysis. The experiment is repeated using a commercial 18 g/l EC formulation of Abamectin for comparison. Table 8 shows the stability of the prepared emulsions along with results from the conventional EC formulation of Abamectin. The table indicates that the stability of Abamectin under the exposure of light is greater for the emulsion prepared according to example 1 than for the comparative commercial EC formulation.

TABLE 8
Stability of Abamectin in a EW formulation when exposed to light for a
period of two hours. The applied amount of Abamectin corresponds to a
concentration of approximately 18 ppm in the final analysis.

| | Abamectin | | |
|---|---|---|---|
| | two | Abamectin | |
| | hours in | two hours light | % Abamectin |
| | darkness | exposure | after exposure |
| | (ppm) | (ppm) | to light |
| EC | 17.7 | 11.8 | 66.6 |
| commercial | | | |
| Emulsion | 15.9 | 13.0 | 81.8 |

The results are the average of two tests in each case.

### Example 10

Abamectin 18 g/l oil-in-water formulations were produced according to the description in example 1. The composition of one of the produced formulations was exactly as outlined in example 1. Other formulations contained either less emulsifying agent or the methylated fatty acid designated Agnique ME 12 C-F instead of the Agnique ME 890G mentioned in example 1. Finally, one formulation was produced, that had a reduced content of Agnique ME 890G and octanol in comparison with the formulation described in Example 1. The produced Abamectin 18 g/l oil-in-water formulations were tested for phytotoxicity on cucumbers and tomatoes. Traditional commercially available Abamectin 18 g/l EC formulations were used as references in the tests. In some tests an emulsifiable mineral oil (crop oil) was applied on the plants together with the Abamectin formulations. The percentage of leaf necrosis was used as the test parameter for phytotoxicity. For the tested 18 g/l EC formulations, the leaf necrosis appeared a few days after the application of the Abamectin formulations. Equal doses of Abamectin EC and oil-in-water formulations were sprayed on the plants. The results are tabulated below.

TABLE 9
Phytotoxicity, i.e., percentage of leaf necrosis, measured on cucumber
and tomato plants a few days after application of Abamectin 18 g/l
oil-in-water formulations and Abamectin 18 g/l EC formulations.

| | Cucumber | Cucumber | Cucumber | Cucumber | Tomato |
|---|---|---|---|---|---|
| Formulation | Test 1 | Test 2 | Test 3 | Test 4 | Test 5 |
| EC version I | 1% | — | — | — | — |
| EC version I + | — | 2% | 3% | 3% | 2% |
| mineral oil | | | | | |
| EC version II | — | — | — | — | — |
| EC version II + | — | — | — | 2% | 1% |
| mineral oil | | | | | |
| EW formulation | 0% | — | — | — | — |
| according to Ex. 1 | | | | | |
| EW formulation | — | 0% | 0% | 0% | — |
| according to Ex. 1 + | | | | | |
| mineral oil | | | | | |
| EW formulation | 0% | — | — | 0% | 0% |
| Reduced content of | | | | | |
| emulsifier + | | | | | |
| mineral oil | | | | | |
| EW formulation | — | — | — | 0% | — |
| containing Agnique | | | | | |
| ME 12 C-F + | | | | | |
| mineral oil | | | | | |
| EW formulation - | 0% | — | — | — | — |
| Reduced content of | | | | | |
| Agnique ME 890G | | | | | |
| and octanol | | | | | |
| Mineral oil alone | — | 0% | 0% | 0% | 0% |

Equal doses of Abamectin formulated as an EC and oil-in-water formulations were sprayed on the plants.

The test results showed that the Abamectin oil-in-water formulations had lower phytotoxicity than the traditional Abamectin EC formulations.

### Example 11

Field trials were conducted with oil-in-water formulation prepared according to the description in example 1 showing that the EW and a commercial EC formulation had comparable efficacies in the control of citrus red mites (Panonychus citri) on orange trees, see table 10.

TABLE 10
Efficacy of Abamectin for the control of citrus red mite
(Panonychus citri). The trial was conducted on 23 year old ‘Washington’
navel orange trees. Evaluations of live mites on 20 leaves per tree.
Mean Number of Female Citrus Red Mites per Leaf + S.E.

| Treatment | Rate g AI/ha | Pretreatment | 14 DAA | 21 DAA |
|---|---|---|---|---|
| Control (water) | — | 0.63 ± 0.17a | 0.43 ± 0.10a | 0.89 ± 0.20a |
| AgriMek 0.15 | 13.2 | 0.61 ± 0.10a | 0.05 ± 0.03b | 0.38 ± 0.05b |
| EC | | | | |
| Abamectin | 13.2 | 0.59 ± 0.09a | 0.03 ± 0.02b | 0.29 ± 0.07b |
| EW | | | | |

Means within a column followed by the same letter are not significantly different (LSD, p = 0.05) after log₁₀ (x + 1) transformation.
Untransformed means are listed.
DAA = days after application.

Under the reported field trial also the presence of the predaceous mite Euseius tularensis was monitored. Results showed no significant difference between the effect of the commercial EC and the formulation prepared according to the present invention, se table 11.

TABLE 11
Effects of Abamectin on the predaceous mite, Euseius tularensis. The
trial was conducted on 23 year old ‘Washington’ navel orange
trees. Evaluations of live mites on 20 leaves per tree.
Mean Number of Euseius tularensis per Leaf + S.E.

| Treatment | Rate g AI/ha | Pretreatment | 14 DAA | 21 DAA |
|---|---|---|---|---|
| Control (water) | | 0.08 ± 0.04a | 0.23 ± 0.03a | 0.15 ± 0.07a |
| AgriMek 0.15 | 13.2 | 0.15 ± 0.05a | 0.10 ± 0.03b | 0.10 ± 0.05a |
| EC | | | | |
| Abamectin EW | 13.2 | 0.05 ± 0.02a | 0.06 ± 0.03b | 0.22 ± 0.11a |

Means within a column followed by the same letter are not significantly different (LSD, p = 0.05) after log₁₀ (x + 1) transformation.
Untransformed means are listed.
DAA = days after application

### Example 12

Field trials were conducted with oil-in-water formulation prepared according to description in example 1 showing that the EW's and a commercial EC formulation had comparable efficacies in the control of Psylla pyri in pears in Italy, see table 13. In the trial a common mineral oil, Ovipron Top was used in a rate of 300 ml/hl of spray volume to further increase efficacy and penetration of the active into the plants.

TABLE 13
Efficacy of an 18 g/l Abamectin oil-in-water formulation used in
field trials compared to a commercial Abamectin EC product. Target
specie was Psylla pyri and the crop used was pear. The spray volume
was 500 L/ha/m tree height. Results for a conventional Abamectin EC
formulation are included for comparison.

| | % Efficacy (H-T) | | | |
|---|---|---|---|---|
| | 2 DAA | 5 DAA | 10 DAA | 21 DAA |
| Abamectin 18 g/l EW: | 95.12 | 97.54 | 99.42 | 100 |
| 1.35 g a.i./hl | | | | |
| Abamectin 18 g/l EW: 0.9 g | 84.44 | 86.9 | 87.13 | 91.06 |
| a.i./hl | | | | |
| Vertimec 18 g/l EC: 1.35 g | 94.14 | 96.99 | 98.83 | 100 |
| a.i./hl | | | | |
| Vertimec 18 g/l EC: 0.9 g | 79.74 | 82.19 | 82.46 | 89.48 |
| a.i./hl | | | | |

DAA = days after application.
The data is provided as efficacy in H-T %.

### Example 13

Field trials using an Abamectin EW formulation prepared according to example 1 was applied in strawberries against Tetranychus spp. A total of 3 applications were done with 7 days intervals. The results observed seven days after the last treatment showed no signs of phytotoxicity whereas a similar EW formulation but with a solvent chosen outside the scope of present invention did show symptoms of phytotoxicity.

Similar trials conducted on aubergine and tomato did not show signs of phytotoxicity for Abamectin EW formulations prepared according to example 1. In these trials a commercial Abamectin EC formulation used as comparison showed flower drop, which interferes with fruit development, but this was not observed with EW formulations according to the present invention. Further, trials in apples with Abamectin EW formulations according to the present invention showed no phytotoxicity.

### Example 14

2.86 g Abamectin (94.00%) is dissolved in 73.6 g solvent mix consisting of 32.3 g ethyl caproate, 32.3 g n-octanol and 9.0 g Shell Fluid 2613/8M. A total amount of 1.1 g of preservative, sticker and thickener is added and dissolved. 64.8 g of aqueous phase consisting of a buffer agent, anionic emulsifiers (7% w/w of the emulsion) and water is prepared. Emulsification is performed under vigorous stirring (2000-3000 rpm), the aqueous phase is added to the organic phase and stirring is continued until the volume-surface mean diameter is in the range 1-20 μm. Adjustment of pH (pH 6-7) and viscosity when relevant is done following the emulsification process. The preparation appear as a white non-transparent emulsion. The formulation is both physically stable (<1% phase separation after 14 days storage at 70° C.) and chemically stable and have physical-chemical properties similar to the formulation prepared according to example 1.

TABLE 14

| | % Abamectin after storage at |
|---|---|
| % Abamectin initial | 70° C. for 14 days |
| 2.05 | 2.05 (100%) |

### Example 15

A solvent mixture is prepared by mixing either myristyl myristate, stearyl heptanoate or cetyl palmitate with n-octanol and Shell Fluid at elevated temperature above the melting point of the used alkylated fatty acids (30-40% of total formulation). Abamectin is added and dissolved as is preservative and sticker (0.6% of total formulation). The water phase is prepared consisting of buffer, emulsifier (7% of total formulation) and thickener and stirred until homogeneous. Emulsification is performed under vigorous stirring (2000-3000 rpm), the aqueous phase is added to the organic phase and stirring is continued until the volume-surface mean diameter is in the range 1-20 μm. The temperature is lowered to room temperature and when relevant pH (pH 6-7) and viscosity is adjusted. The preparation appears as white non-transparent emulsions. The preparation is both physically stable (<1% phase separation when stored at 40° C.) and chemically stable and have physical-chemical properties similar to the formulation prepared according to example 1.

TABLE 15

| | | | % Abamectin |
|---|---|---|---|
| | % Abamectin | Storage at 40° C. | after storage |
| Fatty acid | initial | (days) | (% of initial) |
| Myristyl myristate | 2.08 | 7 | 2.05 (99%) |
| Stearyl heptanoate | 1.08 | 7 | 1.07 (99%) |
| Cetyl palmitate | 2.2 | 4 | 2.17 (99%) |

1.-29. (canceled)

30. A concentrated oil-in-water emulsion formulation for crop protection against pests, comprising
a) one or more pesticidal active ingredients selected among avermectins,
b) one or more solvents selected among (C₁-C₂₀) -alkyl (C₅-C₂₂)-fatty acid esters,
c) an emulsifier system comprising one or more surfactants,
d) water, and
e) one or more co-solvents having a solubility in water of less than 10% at 25° C.,
wherein the pH-value of the emulsion is higher than 3 and the amount by weight of co-solvent is equal to or higher than the amount by weight of avermectin.

31. A formulation according to claim 30, wherein the esters of fatty acids are esters of plant oils.

32. A formulation according to claim 30, wherein the pH of the emulsion is between 3 and 12.

33. A formulation according to claim 32, further comprising one or more pH-adjusters.

34. A formulation according to the preceding claim 30, wherein the avermectin(s) is selected among Abamectin, Aversectin C, Doramectin, Emamectin, Eprinomectin, Ivermectin, Lepimectin, Selamectin, mixtures thereof and salts thereof.

35. A formulation according to claim 30, wherein the avermectin is selected among Abamectin, Aversectin C and Emamectin benzoate.

36. A formulation according to claim 35, wherein the avermectin is Abamectin.

37. A formulation according to claim 30, wherein the component b) is selected among alkyl esters of fatty acids wherein the fatty acids have a carbon chain length of 5-20.

38. A formulation according to claim 30, wherein the component b) is selected among alkyl esters of fatty acids wherein the fatty acids have a carbon chain length of 6-18.

39. A formulation according to claim 30, wherein the component b) is selected among alkyl esters of fatty acids wherein the alkyl part of the fatty acid esters consists of 1-18 carbon atoms.

40. A formulation according to claim 39, wherein the component b) is selected among alkyl esters of fatty acids wherein the alkyl part of the fatty acid esters consists of 1-6 carbon atoms.

41. A formulation according to claim 40, wherein the component b) is selected among alkyl esters of fatty acids wherein the alkyl part of the fatty acid esters consists of 1-3 carbon atoms.

42. A formulation according to claim 41, wherein the component b) is selected among methyl esters of fatty acids.

43. A formulation according to claim 42, wherein the component b) is selected among methyl esters of fatty acids wherein the fatty acids have a carbon chain length of 7-16.

44. A formulation according to claim 30, wherein the co-solvent is selected among straight, branched or cyclic C5-C12 aliphatic hydrocarbons, straight or branched C5-C10 aliphatic alcohols, cyclic aliphatic ketones and mineral oils.

45. A formulation according to claim 44, wherein the co-solvent is selected among straight or branched C5-C10 aliphatic alcohols and cyclohexanone, optionally in combination with one or more mineral oils.

46. A formulation according to claim 45, wherein the co-solvent is selected among hexanol and octanol optionally in combination with one or more mineral oils.

47. A formulation according to claim 30, wherein the weight ratio of avermectin to co-solvent is from 1:1 to 1:20.

48. A formulation according to claim 47, wherein the concentration of avermectin is between 1 and 5% by weight.

49. A formulation according to claim 30, wherein the amount of co-solvent(s) is(are) between 5 and 20% by weight.

50. A formulation according to claim 30, which further comprises one or more further auxiliaries selected from the groups of thickeners, film-forming agents, antifreeze agents, preservatives, antifoaming agents, spreading agents, stickers, wetting agents, structuring agents, stabilisers, UV-protectants and additional insecticides.

51. A formulation according to claim 30, wherein the pH-value of the emulsion is between 4 and 12.

52. A formulation according to claim 51, wherein the pH-value is between 4 and 11.

53. A formulation according to claim 52, wherein the pH-value is between 5 and 10.

54. A formulation according to claim 53, wherein the pH-value is between 6 and 9.

55. A process for producing an oil-in-water emulsion formulation as claimed in claim 30, comprising the steps of:
I. preparing an organic phase comprising the one or more esters of fatty acids, the one or more avermectin(s), the one or more co-solvent(s) having a solubility in water of less than 10% at 25° C., and optionally further auxiliaries in the organic phase;
II. preparing an aqueous phase comprising water, the emulsifier system comprising one or more surfactants, and optionally further hydrophilic auxiliaries; and
III. mixing the organic phase and the aqueous phase under agitation to obtain an oil-in-water emulsion.

56. A method for the control of pests comprising applying an oil-in-water emulsion formulation as claimed in claim 30 to pests, plants, plant seeds, soil or surfaces infested with pests.

57. A method according to claim 56, wherein the formulation is applied in diluted form.

58. A method according to claim 57, wherein the formulation is applied to plants or plant seeds.
